(19) United States
(12) Patent Application Publication
(10) Pub. No.: US 2013/0089650 A1
(43) Pub. Date: Apr. 11, 2013

(54) Method of Precooking the Surface of Food Products with a View to Marking Them or Hardening Them

(71) Applicants: Franck Cousin, Saint Brevin Les Pins (FR); Maryline Perrot-Minot, Verlieu (FR)

(72) Inventors: Franck Cousin, Saint Brevin Les Pins (FR); Maryline Perrot-Minot, Verlieu (FR)

(73) Assignee: L'AIR LIQUIDE SOCIETE ANONYME POUR L'ETUDE ET L'EX, PARIS (FR)

(21) Appl. No.: 13/704,746

(22) PCT Filed: Jun. 1, 2011
(86) PCT No.: PCT/FR11/51257

§ 371 Date: Dec. 17, 2012

(30) Foreign Application Priority Data
Jun. 17, 2010 (FR) 1054830

(51) Int. Cl. A23L 1/01; A21D 13/00

(52) U.S. Cl. CPC A23L 1/01; A21D 13/00
USPC 426/479; 426/523

(57) ABSTRACT

The invention relates to a preferably continuous method for precooking the surface of food products, characterized in that all or part of the surface of the product makes contact with the flame produced by a burner, the flame employed being an oxyhydrogen flame, preferably a hydrogen/oxygen flame.

The present invention relates to the field of methods for cooking the surface of food products; it relates in particular to the case of meat products; it also relates to the case of sandwich bread, most particularly to the case of so-called “crust-free” sandwich bread.

It is known that one of the new markets in this industrial sector is constantly looking for methods which make it possible to reduce the cooking time for these products, while preserving a “grill cooking” appearance or marking which gives the final consumer the sensation of a handmade product.

There is thus known the recent proposal in supermarket departments for meat for grilling (for example entrecote steak or ground beef) in packaging, in the fresh food department, the products being “premarked” (the drawing of the marking giving them the appearance of grill cooking, with the characteristic bands at the surface), they are then ready to be cooked, in a frying pan, in a microwave oven or the like, but in any case in a very short time, in order to attract consumers who are constantly pressed for time (typically 1 to 2 minutes).

It remains the case that these pretreatments represent a real challenge in order to comply with regulations and in particular to ensure an average temperature during the “precooking” or “marking” process that is less than what the regulation recommends.

In practice, manufacturers use a thermal marking stage (grills, ovens and the like) followed by a rapid cooling stage in order to comply with the legislation on fresh products since indeed, according to this legislation, it is forbidden to sell a product termed “fresh” if this product is or has been frozen, therefore has gone below its freezing plateau. By way of example, mention may be made of the case of bovine meat containing 20% fat, having a freezing plateau at −1.17° C., this plateau is therefore very easy to reach.

The challenge for the manufacturers is therefore to mark the surface without transferring too much heat into the product, so as to then not have to go into an excessively “violent” cooling system, dropping below the freezing plateau.

Moreover, fresh products should not exceed 4° C. in order to remain within the control of bacterial development (a temperature of 4° C. is what is traditionally recommended in domestic refrigerators).

It is then observed in practice, on the one hand, that these systems are expensive and cumbersome, on the other hand the fact that the temperatures obtained after the heating (marking) method are too high, requiring the involvement downstream of deep-freezing systems in order to rapidly inhibit heat transfer to the center of the product, deep-freezers which too often result in a drop at the surface that is too cold, below the freezing point.

It should be mentioned that such products are also to be found in the deep-frozen goods department, the products being subjected, after thermal marking, to a deep-freezing step; here again the consumer has to be able to cook this product in a frying pan or in a microwave oven or the like, and in a very short time, while preserving this “marked grill” appearance. It is obvious that the marking of such products before they are frozen then poses fewer technical constraints.

One of the objectives of the present invention is therefore to provide a novel method for “precooking” or “marking” such meat products, which makes it possible to provide a better response (and in particular a more reliable response) to all the technical expectations of this industrial sector; it indeed focuses on solving the problem at its root: controlling the thermal marking of the product so as to not have to cool it.

However, as mentioned above, the present invention also relates to the case of sandwich bread, and in particular to the case of crust-free sandwich bread.

The cutting or the slicing of so-called soft products such as sandwich bread causes difficulties in existing industrial processes, especially when high cutting rates are necessary. By way of illustration, sandwich bread manufacturing lines commonly reach 2400 bread loaves per hour.

By definition, given that the product is soft, the original shape of the product is not stabilized during the cutting, hence the observation of the following phenomena:
irregularities observed on the slice;
sliding of blades on the product, which causes slowing down and the production of fines (bread particles for example);
heating of the cutting blades causes micro-fusions on the product.

It is known that solutions have been proposed for “crustation” of the surface of such products before cutting, by providing cold or heat, in order to preserve the shape of the product during its arrival for the cutting.

It is known that the term “crustation” commonly denotes, in this industry, the action of partially hardening the product, on at least one of its surfaces, most often before a subsequent operation which may be freezing to the center in another device or which may also be an operation which is not freezing, such as slicing, coating and the like.

Let us now return to the two techniques mentioned above of crustation of soft products by supplying cold or heat. As will be explained below, they have disadvantages:
the technique of supplying heat aims to cook the surface of the product, in order to stiffen it and thus improve the cutting behavior, most often by the use of infrared as in the document EP-1 586 428. This technique causes, in most cases, a change in appearance on the product, which is of course damaging. The effect of cooking the surface is often obtained by the application of infrared, it being necessary for the contact time to be short in order not to impact the average temperature of the product.

Under these conditions, it is difficult to find optimum settings between crustation and excessive rise in temperature, in particular when it is necessary to respond to high cutting rates.

It should also be mentioned that, in this process, it is necessary to refrigerate the foodstuffs after treating with infrared, in order to prevent proliferation of bacteria.

The document EP-1 586 428 cited above illustrates the state of the art in this sector; the document aims to provide conditions for the manufacture of crust-free sliced sandwich bread, comprising the steps of cooking the sandwich bread, removing the side crust from the sandwich bread and cross-sectional slicing of the crust-free sandwich bread, where the sandwich bread is subjected, after the step of removing the crust and before the slicing step, to infrared radiation for a defined period;
the technique for supplying cold aims, for its part, to rapidly deep-freeze the surface of the product, in order to stabilize the surface thereof, while hardening it, before the subsequent slicing.

These crustations using cold may be carried out in equipment for mechanical cold or for cryogenic cold.

The disadvantages associated with these cold techniques are in particular the following:
the need to install in the manufacturing chain an additional piece of equipment for carrying out the crustation, which generates, on the one hand, a cost and, on the other hand, the need for additional surface on the floor;
the low temperatures generated at the surface of the product cause trapping of water which can accelerate bacterial growth and particularly mold growth in the case of sandwich bread.

As will be seen in greater detail in the text which follows, the present invention provides a method for “precooking” or “marking” or “crustation” of the surface of food products, and in particular, but these are only some of the possible applications, of meat products or of sandwich bread, which uses an oxyhydrogen flame H₂/O₂ or H₂/air, a flame with considerable advantages, and in particular the following:
the use of an oxyhydrogen flame makes it possible to control the temperatures for the heat treatment: hydrogen has a naturally low calorific power, which makes it possible to achieve low flame temperatures (2.8 kWh/m³ for hydrogen, 9.4 for methane, 24 for propane, and the like), which transfer little energy;
oxygen and action on the oxygen content makes it possible to reduce the temperature of the flame (by superoxygenating) in order to adjust to the characteristics of the targeted treatment;
the distance between the product and the burner determines the treatment temperature, the adiabatic temperature of the flame not being the most distant from the burner. The temperature being set, the treatment time remains to be adjusted by setting the burner passing speed, in order to observe a temperature/time pair;
hydrogen generates higher heat transference in convection, at the expense of transference by radiation (infrared of the prior art) which, for its part, penetrates into the product (which is not desirable; it should be recalled that it is desired here to cook or precook only superficially, in no way to carry out a heat treatment deep into the meat or the bread, which has the risk of cooking them to the center);
the use of “noble” gases such as hydrogen and oxygen makes it possible to obtain clean combustion, without emission of harmful gases and without production of soot.

It is possible to use, for such a treatment according to the invention, commercially available burners and in particular burners that are moreover known from other industries, in particular glass industries (FMT burners, tube in hole burners, and the like).

The present invention therefore relates to a method for cooking (precooking) the surface, preferably continuously, of food products, characterized in that all or part of the surface of the product is brought into contact with the flame produced by a burner, the flame used being an oxyhydrogen flame, preferably a hydrogen/oxygen flame.

The present invention finds a most particularly advantageous application for the treatment of processed products based on meat or meat pieces such as pieces for grilling, in particular for treatments for “marking” the surface of meat for sale of the piece in the fresh food department, but as has been seen, such markings are of interest for other products such as cheese.

In addition, according to one of the embodiments of the invention, the treatment for cooking the surface according to the invention is not followed by any treatment for cooling the treated piece.

However, according to another of the embodiments of the invention, it finds application in the field of deep-frozen products, and thus, after precooking with a flame at the surface in accordance with the invention, the product is subjected to a deep-freezing step (by one of the multiple methods available in this industry, whether deep-freezing with so-called mechanical cold or whether cryogenic cold).

The present invention also finds a most particularly advantageous application for the manufacture of crust-free sliced sandwich bread, the manufacture comprising at least the following steps:
a step for cooking a preparation leading to the production of a cooked sandwich bread;
a step for removing the side crust from the sandwich bread;
a step which makes it possible to cross-sectionally slice the crust-free sandwich bread in order to obtain the desired crust-free and sliced sandwich bread, and where, in accordance with the invention, all or part of the side surface of the crust-free sandwich bread is subjected, before the slicing step, to contact with a flame produced by a burner, the flame used being an oxyhydrogen flame, preferably a hydrogen/oxygen flame.

According to particular or advantageous embodiments of the invention, it can adopt one or more of the following technical characteristics:
the treated products are processed products based on meat or meat pieces;
the treated products are sandwich bread whose crust has been removed, the treatment taking place before slicing;
the treatment for precooking the surface according to the invention is not followed by any treatment for cooling the product or the treated piece;
the treatment for precooking the surface according to the invention is followed by a step for deep-freezing the product or the treated piece.

Other characteristics and advantages of the present invention will therefore emerge more clearly in the following description, given by way of illustration but not at all limiting, giving the conditions for practical examples for carrying out the invention. These examples were obtained under the operating conditions detailed below; the results of water loss, after cooking of the product by the final user, in each case, are given in the text that follows.

In a first series of trials, the treated products were ground beef of about 45 grams, characterized by a fat content close to 20%, precooked on the surface according to the invention with an H₂/O₂ flame, and then cooked in a microwave oven as a final user would do.

The difference in weight (mean of weights for three products each time), before and after final cooking in a microwave oven, depending on whether the steak was or was not precooked on the surface with the flame according to the invention (some steaks were therefore raw, not treated by the invention, but treated in a microwave oven) was therefore determined.

The results obtained speak for themselves; they demonstrate a water loss that is unquestionably lower when the product was precooked with the flame according to the invention:
not precooked according to the invention:
   Weight before final cooking: 45.68 g
   Weight after final cooking: 35.52 g
   Difference in weight: 10.16 g
according to the invention:
   Weight before final cooking (precooked on the surface): 44.47 g
   Weight after final cooking: 37.80 g
   Difference in weight: 6.67 g

Other tests were carried out with steaks having a fat content close to 17%; here again they demonstrate a water loss that is unquestionably lower when the product was precooked with the flame according to the invention:
not precooked according to the invention:
   Weight before final cooking: 44. 86 g
   Weight after final cooking: 39.86 g
   Difference in weight: 5 g
according to the invention:
   Weight before final cooking (precooked on the surface): 43.88 g
   Weight after final cooking: 41.98 g
   Difference in weight: 1.9 g

The results developed above illustrate the case of meat products; by way of illustration, an example of an embodiment of the invention for treating crust-free sandwich bread, before slicing thereof, is described below:
bread from the step for removing the crust circulate (in the direction of their length) on a stainless steel belt, a certain number of burners are placed parallel to the product on its top face and on its side faces (three faces will be treated here);
after having been subjected to the heat treatment and before the bread reaches the cutting blades, it is made to make a quarter rotation on itself (typically in the clockwise direction) and then the parallelepiped rectangle which the bread represents will topple over by a quarter, so that the face which has not been subjected to a heat treatment is now at the back (opposite the blades).

It can thus be seen that it is not necessary to treat all the faces of the bread, 3 faces make it possible to obtain the desired result.

1-5. (canceled)

6. A method for precooking the surface of food products, characterized in that all or part of the surface of the product is brought into contact with a flame from a burner produced by combustion of hydrogen and either air or oxygen.

7. The method for precooking the surface of claim 6, wherein the food products are based on meat or meat pieces.

8. The method for precooking the surface of claim 6, wherein after the surface of the product is brought into contact with the flame, product is not cooled.

9. The method for precooking the surface of claim 6, further comprising the step of deep-freezing the product after the surface of the product is brought into contact with the flame.

10. A method for manufacture of crust-free sliced sandwich bread, comprising the steps of:
cooking a preparation to result in cooked sandwich bread;
removing a side crust from the sandwich bread;
all or part of a side surface of the crust-free sandwich bread is contacted with a flame produced from a burner through combustion of hydrogen and either air or oxygen; and
after the bread is contacted with the flame, cross-sectionally slicing the crust-free sandwich bread.
